(19) United States
(12) Patent Application Publication
(10) Pub. No.: US 2022/0004753 A1
(43) Pub. Date: Jan. 6, 2022

(54) INFORMATION PROCESSING APPARATUS, NON-TRANSITORY COMPUTER READABLE MEDIUM, AND INFORMATION PROCESSING METHOD

(71) Applicant: TOYOTA JIDOSHA KABUSHIKI KAISHA, Toyota-shi (JP)

(72) Inventors: Satoshi KOMAMINE, Nagoya-shi (JP); Hideo HASEGAWA, Nagoya-shi (JP)

(73) Assignee: TOYOTA JIDOSHA KABUSHIKI KAISHA, Toyota-shi (JP)

(21) Appl. No.: 17/346,996

(22) Filed: Jun. 14, 2021

(30) Foreign Application Priority Data
Jul. 1, 2020 (JP) 2020-114482

(51) Int. Cl. G06K 9/00; H04N 7/18; G06F 3/16; H05B 47/105

(52) U.S. Cl. CPC G06K 9/00442; H04N 7/183; G06K 2209/501; G06F 3/16; H05B 47/105; G06K 9/00771

(57) ABSTRACT

An information processing apparatus includes a communication interface and a controller. The controller is configured to execute estimation processing for estimating content of a book. The controller is configured to transmit, to an external apparatus, a control signal in accordance with the content of the book using the communication interface.

### CROSS-REFERENCE TO RELATED APPLICATION

This application claims priority to Japanese Patent Application No. 2020-114482 (filed on Jul. 1, 2020), the entire contents of which are incorporated herein by reference.

### TECHNICAL FIELD

The present disclosure relates to an information processing apparatus, a program, and an information processing method.

### BACKGROUND

A known lighting apparatus adjusts a light environment so that the light environment will be kept constant for a task performed in a space (for example, Patent Literature [PTL] 1).

### CITATION LIST

### Patent Literature

PTL 1: JP 2013-041718 A

### SUMMARY

It is required to adjust a surrounding environment of a user in accordance with a situation or the like of the user.

It would be helpful to adjust the surrounding environment of the user in accordance with the content of a book that the user is viewing.

An information processing apparatus according to an embodiment of the present disclosure includes:

a communication interface; and

a controller configured to execute estimation processing for estimating content of a book, and transmit, to an external apparatus, a control signal in accordance with the content of the book using the communication interface.

A program according to an embodiment of the present disclosure is configured to cause a computer to execute operations, the operations including:

executing estimation processing for estimating content of a book; and

transmitting, to an external apparatus, a control signal in accordance with the content of the book.

An information processing method according to an embodiment of the present disclosure includes:

executing estimation processing for estimating content of a book using an information processing apparatus; and

transmitting, to an external apparatus, a control signal in accordance with the content of the book using the information processing apparatus.

According to an embodiment of the present disclosure, the surrounding environment of the user can be adjusted in accordance with the content of the book that the user is viewing.

### BRIEF DESCRIPTION OF THE DRAWINGS

In the accompanying drawings:

FIG. 1 illustrates a configuration of an information processing system according to an embodiment of the present disclosure;

FIG. 2 is a block diagram illustrating a detailed configuration of the information processing system of FIG. 1;

FIG. 3 illustrates categories of scenes and control signals according to the embodiment of the present disclosure;

FIG. 4 illustrates a configuration of a book according to the embodiment of the present disclosure; and

FIG. 5 is a sequence diagram showing an example of operations of the information processing system of FIG. 1.

### DETAILED DESCRIPTION

With reference to the drawings, an embodiment of the present disclosure will be described below. In the components illustrated in the drawings as described below, the same components are denoted by the same numerals.

(Configuration of Information Processing System)

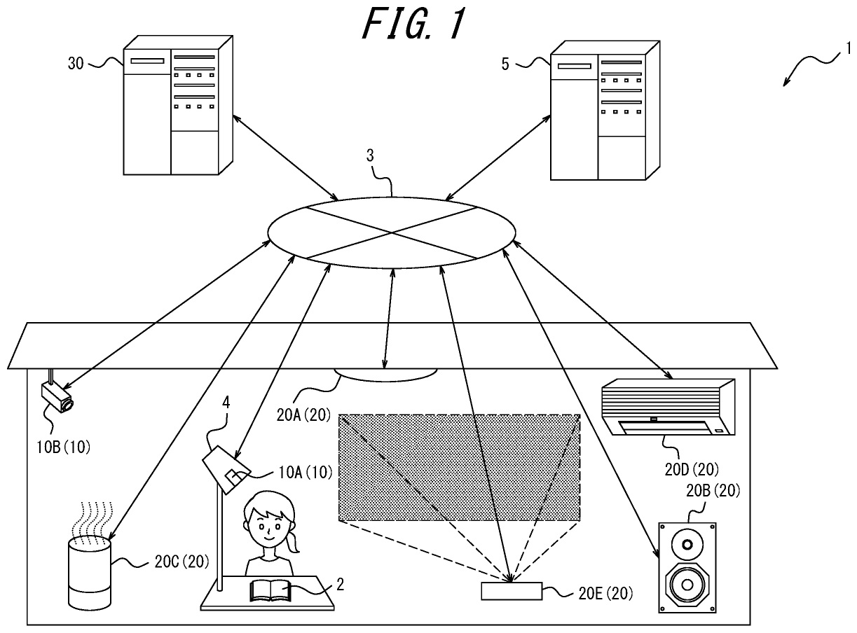

An information processing system 1 according to an embodiment of the present disclosure as illustrated in FIG. 1 is capable of adjusting a surrounding environment of a user in accordance with the content of a book 2 that the user is viewing. The book 2 may be a book that presents visual information to the user. The visual information may be, for example, text, pictures, illustrations, photos, or the like. The book 2 may be any medium that allows the book 2 to present the visual information. For example, the book 2 is a paper medium, an electronic medium, or the like. When the book 2 is an electronic medium, the book 2 can also be referred to as an “electronic book”.

Herein, if the user is viewing the book 2, this means that the user's gaze is directed to the book 2. For example, in a case in which the book 2 is a novel, if the user is viewing the book 2, this may include the user reading text presented by the book 2. For example, in a case in which the book 2 is a photo book, if the user is viewing the book 2, this may include the user looking at photos presented by the book 2. Hereinafter, the user is assumed to be inside a room as illustrated in FIG. 1. In this situation, the surrounding environment of the user can be an environment inside the room. The surrounding environment of the user is, however, not limited to being inside the room, as will be described later.

As illustrated in FIG. 1, the information processing system 1 includes cameras 10A,10B, external apparatuses 20A, 20B, 20C, 20D, 20E, and an information processing apparatus 30.

Hereinafter, the cameras 10A, 10B, are also described collectively as “cameras 10” unless particularly distinguished. FIG. 1 illustrates the information processing system 1 as including two cameras 10. However, it is sufficient for the information processing system 1 to include at least one camera 10.

Hereinafter, the external apparatuses 20A through 20E are also described as “external apparatuses 20” unless particularly distinguished. FIG. 1 illustrates the information processing system 1 as including five external apparatuses 20. However, it is sufficient for the information processing system 1 to include at least one external apparatus 20.

The cameras 10, the external apparatuses 20, and the information processing apparatus 30 are communicable via a network 3. The network 3 may be any appropriate network, such as a mobile communication network or the Internet. In a case in which the book 2 is an electronic book, the information processing apparatus 30 and the book 2 may be communicable via the network 3. The information processing apparatus 30 and a later-described external server 5 may be communicable via the network 3.

The user can read the book 2 under illumination light from a desk lamp 4. The user may switch on the desk lamp 4 when they start reading the book 2. The user may switch off the desk lamp 4 when they stop reading the book 2.

Each camera 10 may capture an image of a subject to generate a captured image. The camera 10 may be located at a position from which an image of the book 2 as the subject can be captured while the user is viewing the book 2 in the room. For example, the camera 10A is located on the desk lamp 4 so as to be capable of capturing an image of the book 2 as the subject. Further, each camera 10 may be located at a position from which an image of the user, along with the book 2, as the subject may be captured. For example, the camera 10B is located on a wall or the like in the room so as to be capable of capturing an image of the user, along with the book 2, as the subject. The camera 10B may be a monitor camera or the like.

The external apparatuses 20 may be located in the surroundings of the user. When the user is inside the room, the surroundings of the user can be inside the room. In the present embodiment, the external apparatuses 20 may be located inside the room that is the surroundings of the user.

The external apparatuses 20 can be apparatuses that stimulate the user's senses. The user's senses may include the user's vision, the user's hearing, the user's sense of smell, the user's sense of temperature, the user's sense taste, or the like. For example, the external apparatus 20A is a lighting apparatus that stimulates the user's vision. The external apparatus 20A may be a ceiling light, any other lighting fixture, or the like. For example, the external apparatus 20B is an acoustic apparatus that stimulates the user's hearing. For example, the external apparatus 20C is an aroma diffuser that stimulates the user's sense of smell. For example, the external apparatus 20D is an air conditioner that stimulates the user's sense of temperature. For example, the external apparatus 20E is a projection apparatus that stimulates the user's vision. The external apparatus 20E may be located in a position from which an image can be projected to the wall or the like in the room.

As will be described later, the information processing apparatus 30 estimates the content of the book 2 that the user is viewing. The information processing apparatus 30 transmits, to the external apparatuses 20, a control signal in accordance with the estimated content of the book 2. By the control signal being transmitted to the external apparatuses 20, the functions of the external apparatuses 20 can be controlled in accordance with the estimated content of the book 2. With the above configuration, the environment inside the room as the surrounding environment of the user can be adjusted in accordance with the estimated content of the book 2. These processes will be described later in detail.

The information processing apparatus 30 may be a dedicated computer configured to function as a server, a general-purpose personal computer, a cloud computing system, or the like.

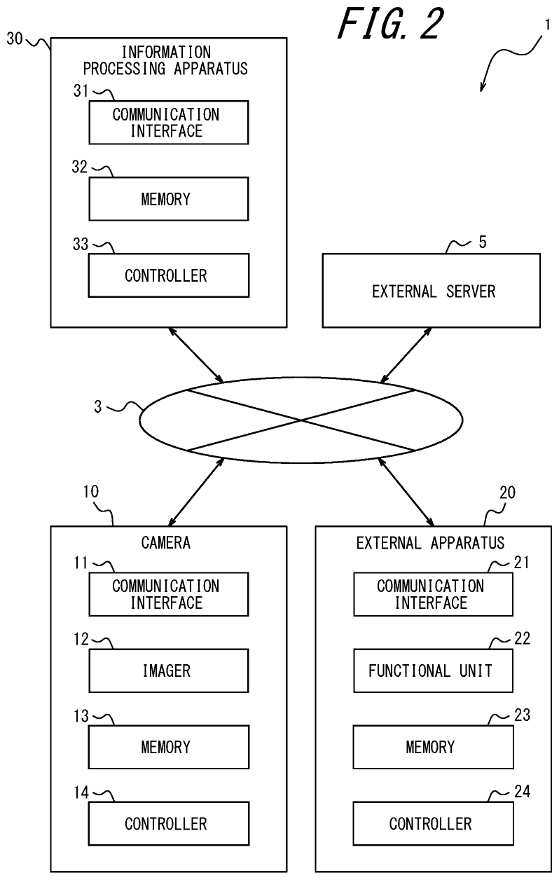

As illustrated in FIG. 2, the cameras 10 each include a communication interface 11, an imager 12, a memory 13, and a controller 14.

The communication interface 11 may include at least one communication module that is connectable to the network 3. For example, the communication module is a module compliant with a standard such as a wired Local Area Network (LAN) or a wireless LAN. The communication interface 11 is connectable to the network 3 via the wired LAN or the wireless LAN using the communication module.

The imager 12 may include imaging optics and an imaging element. Based on control by the controller 14, the imager 12 captures an image of the subject and generates a captured image. The imager 12 outputs, to the controller 14, data of the generated captured image. The imager 12 may capture images at any frame rate based on the control by the controller 14.

The memory 13 may include at least one semiconductor memory, at least one magnetic memory, at least one optical memory, or a combination of at least two of these. The semiconductor memory is, for example, Random Access Memory (RAM) or Read Only Memory (ROM). The RAMs is, for example, Static Random Access Memory (SRAM) or Dynamic Random Access Memory (DRAM). The ROM is, for example, Electrically Erasable Programmable Read Only Memory (EEPROM). The memory 13 may function as, for example, a main memory, an auxiliary memory, or a cache memory. The memory 13 stores data to be used for the operations of the cameras 10 and data obtained by the operations of the cameras 10.

The controller 14 includes at least one processor, at least one dedicated circuit, or a combination thereof. The processor is a general-purpose processor such as a Central Processing Unit (CPU) or a Graphics Processing Unit (GPU), or a dedicated processor that is dedicated to specific processing. Examples of dedicated circuits may include a Field-Programmable Gate Array (FPGA) and an Application Specific Integrated Circuit (ASIC). The controller 14 may perform processing related to the operations of the cameras 10 while controlling individual parts of the cameras 10.

The controller 14 may acquire the data of the captured image from the imager 12. The controller 14 may transmit, via the network 3 to the information processing apparatus 30, information indicating an identifier of the camera 10 and the data of the captured image captured by the imager 12, using the communication interface 11.

In the camera 10A, the controller 14 may cause the imager 12 to start generating the captured image when the desk lamp 4 is switched on. The camera 10A may be configured to detect switching on of the desk lamp 4. For example, the camera 10A may further include an illuminance sensor capable of detecting the light from the desk lamp 4. When the camera 10A includes the illuminance sensor, in the camera 10A, the controller 14 may cause the imager 12 to start generating the captured image, upon detecting light from the desk lamp 4 using the illuminance sensor. Further, the power supply of the camera 10A may be configured to turn to an on state when the desk lamp 4 is switched on. In this case, in the camera 10A, the controller 14 may cause the imager 12 to start generating the captured image when the power supply of the camera 10A turns to the on state.

In the camera 10A, the controller 14 may cause the imager 12 to continuously generate captured images at any frame rate while the desk lamp 4 is on. In the camera 10A, while the desk lamp 4 is on, the controller 14 may continuously transmit, via the network 3 to the information processing apparatus 30, information indicating the identifier of the camera 10A and data of the captured images captured by the imager 12, using the communication interface 11.

In the camera 10A, the controller 14 may cause the imager 12 to terminate the generation of the captured images when the desk lamp 4 is switched off. That is, in the camera 10A, the controller 14 may terminate the transmission of the data of the captured images or the like to the information processing apparatus 30 when the desk lamp 4 is switched off. When the camera 10A includes the illuminance sensor, the controller 14 may cause the imager 12 to terminate the generation of the captured images, upon detecting the switching off of the desk lamp 4 using the illuminance sensor. Further, the power supply of the camera 10A may be configured to turn to an off state when the desk lamp 4 is on. In this case, when the power supply to the camera 10A is in the off state, the camera 10A may terminate the transmission of the data of the imaging images or the like to the information processing apparatus 30.

For example, in a case in which the camera 10B is a monitor camera, in the camera 10B, the controller 14 may cause the imager 12 to continuously generate captured images at any frame rate. In the camera 10B, the controller 14 may continuously transmit, via the network 3 to the information processing apparatus 30, information indicating an identifier of the camera 10B and data of the captured images generated by the imager 12, using the communication interface 11.

As illustrated in FIG. 2, the external apparatuses 20 each include a communication interface 21, a functional unit 22, a memory 23, and a controller 24.

As is the case with the communication interface 11, the communication interface 21 may include at least one communication module that is connectable to the network 3. As is the case with the communication interface 11, the communication interface 21 is connectable to the network 3 via the wired LAN or the wireless LAN using the communication module.

The functional unit 22 is capable of providing a desired function of the external apparatus 20. The functional unit 22 can be configured appropriately in accordance with the desired function of the external apparatus 20.

The functional unit 22 of the external apparatus 20A is capable of outputting light. In the external apparatus 20A, the functional unit 22 outputs illumination light based on control by the controller 24. The functional unit 22 of the external apparatus 20A may include at least one light source or the like. When the functional unit 22 of the external apparatus 20A includes a plurality of light sources, each light source may be capable of outputting illumination light having a different color.

The functional unit 22 of the external apparatus 20B is capable of outputting sound. In the external apparatus 20B, the functional unit 22 outputs a sound effect and/or music, based on control by the controller 24. The sound effect is, for example, a certain ambient sound for describing a situation depicted in the book 2. The functional unit 22 of the external apparatus 20B may include a speaker or the like.

The functional unit 22 of the external apparatus 20C is capable of diffusing a fragrance, for example, by vaporizing the fragrance. In the external apparatus 20C, the functional unit 22 diffuses the fragrance based on control by the controller 24. When the external apparatus 20C is an ultrasonic aroma diffuser, the functional unit 22 of the external apparatus 20C may include a drive circuit or the like for generating ultrasonic waves. The functional unit 22 of the external apparatus 20C may include at least one fragrance corresponding to the control signal, such as a later-described signal 58.

The functional unit 22 of the external apparatus 20D is capable of adjusting an air temperature inside the room. In the external apparatus 20D, the functional unit 22 adjusts the air temperature inside the room based on the control by the controller 24. The functional unit 22 in the external apparatus 20D may include a heat exchanger or the like.

The functional unit 22 of the external apparatus 20E is capable of projecting an image. In the external apparatus 20E, the functional unit 22 projects the image based on control by the controller 24. The functional unit 22 of the external apparatus 20E may include projection optics and at least one light source.

As is the case with the memory 13, the memory 23 may include at least one semiconductor memory, at least one magnetic memory, at least one optical memory, or a combination of at least two of these. As is the case with the memory 13, the memory 23 may function as, for example, the main memory, the auxiliary memory, or the cache memory. The memory 23 stores data to be used for the operations of the external apparatuses 20 and data obtained by the operations of the external apparatuses 20.

In the memory 23 of the external apparatus 20B, data for reproducing later-described sound effects, data for reproducing later-described music, or the like may be stored. The above data may be individually associated in advance with control signals, such as later-described signals 52, 55, 57. In the memory 23 of the external apparatus 20E, data for reproducing later-described images may be stored. The above data may be individually associated in advance with control signals, such as later-described signals 59, 62.

As is case with the controller 14, the controller 24 may include at least one processor, at least one dedicated circuit, or a combination thereof. The controller 24 may perform processing related to the operations of the external apparatuses 20 while controlling individual parts of the external apparatuses 20.

The controller 24 may receive, via the network 3 from the information processing apparatus 30, the control signal using the communication interface 21. In response to the received control signal, the controller 24 controls the functional unit 22.

In the external apparatus 20A, upon receiving the control signal, the controller 24 can cause the functional unit 22 to output illumination light having a color corresponding to the control signal and/or illumination light having an intensity corresponding to the control signal. For example, in the external apparatus 20A, upon receiving a later-described signal 50 as the control signal, the controller 24 causes the functional unit 22 to output blue illumination light.

In the external apparatus 20B, upon receiving the control signal, the controller 24 can cause the functional unit 22 to output a sound effect corresponding to the control signal and/or music corresponding to the control signal. For example, in the external apparatus 20B, upon receiving the later-described signal 52 as the control signal, the controller 24 reproduces the data that is stored in the memory 23 in correspondence with the signal 52 and causes the functional unit 22 to output music. Further, in the external apparatus 20B, the controller 24 may receive, via the network 3 from the information processing apparatus 30, the data for reproducing a sound effect and/or music, along with control signal, using the communication interface 21. In this case, in the external apparatus 20B, the controller 24 reproduces the received data and causes the functional unit 22 to output the music.

In the external apparatus 20C, upon receiving the control signal, the controller 24 can cause the functional unit 22 to diffuse a fragrance corresponding to the control signal. For example, in the external apparatus 20C, when receiving the later-described signal 58 as the control signal, the controller 24 causes the functional unit 22 to diffuse a fragrance corresponding to the signal 58.

In the external apparatus 20D, upon receiving the control signal, the controller 24 controls the functional unit 22 so that the air temperature inside the room will reach a temperature corresponding to the control signal. For example, in the external apparatus 20D, upon receiving a later-described signal 61 as the control signal, the controller 24 controls the functional unit 22 so that the air temperature inside the room will be lower than a later-described temperature threshold.

In the external apparatus 20E, upon receiving the control signal, the controller 24 can cause the functional unit 22 to output an image corresponding to the control signal. For example, in the external apparatus 20E, upon receiving the signal 59 as the control signal, the controller 24 causes the functional unit 22 to project an image that is stored in the memory 23 in correspondence with the signal 59.

As illustrated in FIG. 2, the information processing apparatus 30 includes a communication interface 31, a memory 32, and a controller 33.

As is case with the communication interface 11, the communication interface 31 may include at least one communication module that is connectable to the network 3. As is the case with the communication interface 11, the communication interface 31 is connectable to the network 3 via the wired LAN or the wireless LAN using the communication module.

As is the case with the memory 13, the memory 32 may include at least one semiconductor memory, at least one magnetic memory, at least one optical memory, or a combination of at least two of these. As is the case with the memory 13, the memory 32 may function as, for example, a main memory, an auxiliary memory, or a cache memory. The memory 32 stores data to be used for the operations of the information processing apparatus 30 and data obtained by the operations of the information processing apparatus 30.

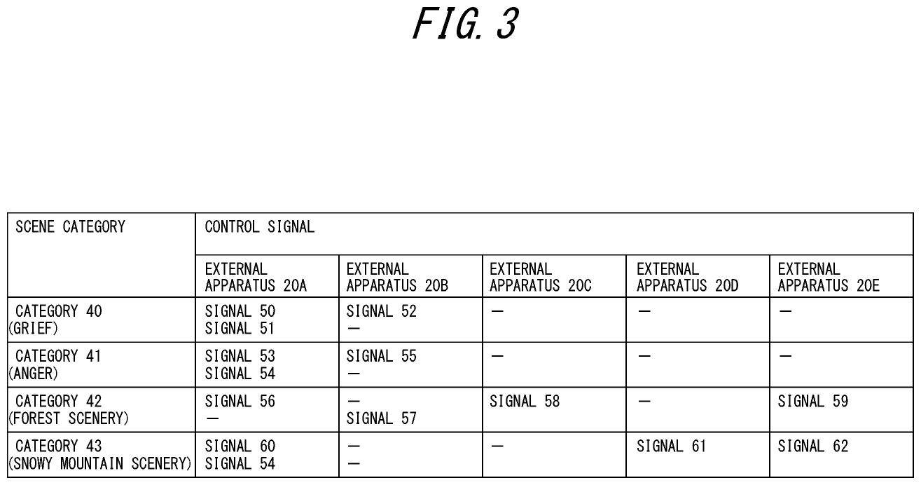

The memory 32 may store information including categories of scenes in correspondence with the control signals, as illustrated in FIG. 3 which will be described later. The memory 32 may store data for reproducing the later-described sound effects and/or data for reproducing the later-described music. The above data may be individually associated in advance with the control signals, such as the later-described signals 52, 55, 57. The memory 32 may store a database for facial recognition. The database for face recognition includes data of a facial image of at least one occupant in a house having the room as illustrated in FIG. 1, in correspondence with an identifier for the occupant.

As is the case with the controller 14, the controller 33 may include at least one processor, at least one dedicated circuit, or a combination thereof. The controller 33 may perform processing related to the operations of the information processing apparatus 30 while controlling individual parts of the information processing apparatus 30.

The functions of the information processing apparatus 30 may be implemented by executing a control program according to the present embodiment by a processor corresponding to the controller 33. That is, the functions of the information processing apparatus 30 may be implemented by software. The information processing program may enable a computer to function as the information processing apparatus 30 by causing the computer to perform the operations of the information processing apparatus 30. That is, the computer can function as the information processing apparatus 30, by executing the operations of the information processing apparatus 30 in accordance with the information processing program.

In the present disclosure, a “program” can be recorded on a computer readable non-transitory recording medium. The computer readable non-transitory recording medium is, for example, a magnetic recording device, an optical disc, a magneto-optical recording medium, or a ROM. The program may be distributed, for example, by selling, transferring, or renting a portable recording medium, such as a Digital Versatile Disc (DVD) or a Compact Disc Read Only Memory (CD-ROM), on which the program is recorded. The program may be stored in a storage of a server. The program may be distributed by being transferred from the server to another computer. The program may be provided as a program product.

In the present disclosure, a “computer” may temporarily store in the main memory, for example, a program recorded on a portable recording medium, or a program transferred from the server. Further, the computer may read the program stored in the main memory using a processor, and execute processes in accordance with the read program using the processor. The computer may read a program directly from the portable recording medium, and execute processes in accordance with the program. The computer may, each time a program is transferred from the server to the computer, sequentially execute processes in accordance with the received program. Without a program being transferred from the server to the computer, the computer may execute processes as a so-called Application Service Provider (ASP)-type service that implements functions only by execution instructions and result acquisitions. Programs encompass information that is to be used for processing by an electronic computer and is thus equivalent to a program. For example, data that is not a direct command to a computer but has a property that regulates processing of the computer is “equivalent to a program” in this context.

Some or all of the functions of the information processing apparatus 30 may be implemented by a dedicated circuit corresponding to the controller 33. That is, some or all of the functions of the information processing apparatus 30 may be implemented by hardware.

<Estimation Processing>

The controller 33 executes estimation processing for estimating the content of the book 2. The content of the book 2 may be represented by visual information that the book 2 presents to the user.

The controller 33 may estimate the content of the book 2 based on the predefined scenes. When determining that the content of the book 2 corresponds to any one of the predefined scenes, the controller 33 may estimate that the content of the book 2 is of the scene. The scenes may be classified by predefined categories. The categories of scenes may be defined appropriately based on what is represented by the visual information that the book 2 presents to the user. In ordinary books, human emotion and scenery are often depicted. Each category of scene may be predefined based on human emotion and/or scenery. The category of scene may correspond to any of categories of human emotion or may correspond to any of categories of scenery. The categories of human emotion are, for example, grief, anger, joy, pleasure, or the like. The categories of scenes are, for example, forests, snow mountains, seas, deserts, or the like. The categories of scenes may include categories 40, 41, 42, 43 as illustrated in FIG. 3.

The categories 40, 41 are each predefined based on human emotion. The category 40 corresponds to grief, which is included in the categories of human emotion. The category 41 corresponds to anger, which is included in the categories of human emotion. The categories 42, 43 are each predefined based on scenery. The category 42 corresponds to forest scenery, which is included in the categories of scenery. The category 43 corresponds to snowy mountain scenery, which is included in the categories of scenery.

Herein, the controller 33 may receive, via the network 3 from the cameras 10, the data of the captured images using the communication interface 31. The controller 33 may execute the estimation processing for the content of the book 2, by analyzing the data of the captured images that has been received from the cameras 10.

As an example, the controller 33 may detect text from an image of the book 2 included in a captured image using character recognition in which any machine-learning algorithm is employed. For example, in the case in which the book 2 is a novel, the book 2 may present text. The controller 33 may estimate the meaning of the text detected, by executing, for the text detected, natural language processing in which any machine-learning algorithm is employed. When determining that the estimated meaning of the text corresponds to any one of the categories of scenes, the controller 33 may estimate that the content of book 2 falls into the category of scene corresponding to the meaning of the text. For example, the controller 33 estimates that the content of the book 2 falls into the category 40 when the estimated meaning of the text indicates grief.

As another example, the controller 33 may detect an object, such as a picture, from the image of the book 2 included in the captured image, and estimate what the detected object is, using object recognition in which any machine-learning algorithm is employed. For example, in a case in which the books is a picture book, the book 2 may present a picture. When the object estimated corresponds to any one of the categories of scenes, the controller 33 may estimate that the content of the book 2 falls into the category of scene corresponding to the object estimated. For example, the controller 33 estimates that the content of the book 2 falls into the category 42 when the object estimated is a forest.

In the case in which the book 2 is an electronic book, the controller 33 may receive, via the network 3 from the book 2, information that the book 2 presents to the user, using the communication interface 31. The controller 33 may estimate the content of the book 2 by analyzing the received information.

<Transmission Processing for Control Signal>

The controller 33 may transmit, to the external apparatuses 20, the control signal in accordance with the estimated content of the book 2 using the communication interface 31. In a case in which the content of the book 2 is estimated according to the categories of scenes, the categories of scenes may be associated with the control signals in advance as illustrated in FIG. 3.

The category 40 is associated in advance with the signal 50 and a signal 51 as the control signals for the external apparatus 20A which is the lighting apparatus. The signal 50 is the control signal that causes the external apparatus 20A to output blue illumination light. The signal 51 is the control signal that causes the external apparatus 20A to output illumination light having an intensity less than an illuminance threshold. The illuminance threshold may be a median value of illuminances that can be set for the external apparatus 20A, or may be an illuminance that is set as a reference value for the external apparatus 20A. How much lower the illumination light will be than the illuminance threshold as a result of the signal 51 may be set appropriately based on the size of an interior space of the room. The category 40 is associated in advance with the signal 52 as the control signal for the external apparatus 20B which is the acoustic apparatus. The signal 52 is the control signal that causes the external apparatus 20B to output music in which grief is depicted. The music in which grief is depicted may be defined appropriately based on the common human emotion.

The category 41 is associated in advance with a signal 53 and the signal 54 as the control signals for the external apparatus 20A which is the lighting apparatus. The signal 53 is the control signal that causes the external apparatus 20A to output red illumination light. The signal 54 is the control signal that causes the external apparatus 20A to output illumination light having an intensity greater than the aforementioned illuminance threshold. How much greater the illumination light will be than the aforementioned illuminance threshold as a result of the signal 54 may be set appropriately based on the size of the interior space of the room. The category 41 is associated in advance with the signal 55 as the control signal for the external apparatus 20B which is the acoustic apparatus. The signal 55 is the control signal that causes the external apparatus 20B to output music in which anger is depicted. The music in which anger is depicted may be defined appropriately based on the common human emotion.

The category 42 is associated in advance with a signal 56 as the control signal for the external apparatus 20A which is the lighting apparatus. The signal 56 is the control signal that causes the external apparatus 20A to output green illumination light. The category 42 is associated in advance with the signal 57 as the control signal for the external apparatus 20B which is the acoustic apparatus. The signal 57 is the control signal that causes the external apparatus 20B to output a forest ambient sound. The forest ambient sound includes, for example, a sound of rustling tree leaves, a wild bird's song, an insect sound, or the like. The category 42 is associated in advance with the signal 58 as the control signal for the external apparatus 20C which is the aroma diffuser. The signal 58 is the control signal that causes the external apparatus 20C to diffuse a fragrance associated with a forest scent. The forest scent includes, for example, a wood scent, a floral scent, a dirt scent, or the like. The category 42 is associated in advance with the signal 59 as the control signal for the external apparatus 20E which is the projection apparatus. The signal 59 is the control signal that causes the external apparatus 20E to output a forest image.

The category 43 is associated in advance with a signal 60 and the signal 54 as the control signals for the external apparatus 20A which is the lighting apparatus. The signal 60 is the control signal that causes the external apparatus 20A to output white illumination light. The category 43 is associated in advance with the signal 61 as the control signal for the external apparatus 20D which is the air conditioner. The signal 61 is the control signal that causes the external apparatus 20D to adjust the air temperature inside the room to be lower than the temperature threshold. The temperature threshold may be a desired temperature that is set for the external apparatus 20D in advance. How much lower the temperature will be than the temperature threshold as a result of the signal 61 may be set appropriately based on the size of the interior space of the room. The category 43 is associated in advance with the signal 62 as the control signal for the external apparatus 20E which is the projection apparatus. The signal 62 is the control signal that causes the external apparatus 20E to output a snowy mountain image.

As the control signal, the controller 33 may transmit, via the network 3 to the external apparatus 20A, a signal to cause output of illumination light having a color in accordance with the content of the book 2 using the communication interface 31. For example, when estimating that the content of the book 2 corresponds to the category 40, the controller 33 transmits the signal 50 to the external apparatus 20A. By the control signal being transmitted to the external apparatus 20A, the external apparatus 20A can output the illumination light having the color in accordance with the content of the book 2. With the above configuration, the color of the light in the surrounding of the user as the surrounding environment of the user can be adjusted to the color of the light in accordance with the content of the book 2. Thus, since the user's vision is stimulated by the light having the color in accordance with the content of the book 2, the user is more likely to sympathize with the content of the book 2.

As the control signal, the controller 33 may transmit, via the network 3 to the external apparatus 20A, a signal to cause output of illumination light having an intensity in accordance with the content of the book 2 using the communication interface 31. For example, when estimating that the content of the book 2 corresponds to the category 40, the controller 33 transmits the signal 51 to the external apparatus 20A. By the control signal being transmitted to the external apparatus 20A, the external apparatus 20A can output the illumination light having the intensity in accordance with the content of the book 2. With the above configuration, the intensity of the light in the surrounding of the user as the surrounding environment of the user can be adjusted to the intensity of the light in accordance with the content of the book 2. Thus, since the user's vision is stimulated by the light having the intensity in accordance with the content of the book 2, the user is more likely to sympathize with the content of the book 2.

As the control signal, the controller 33 may transmit, via the network 3 to the external apparatus 20B, a signal that causes output of a sound effect in accordance with the content of the book 2 using the communication interface 31. For example, when estimating that the content of the book 2 corresponds to the category 42, the controller 33 transmits the signal 57 to the external apparatus 20B. The controller 33 may transmit, to the external apparatus 20B, the data for reproducing the sound effect that is stored in memory 32 in correspondence with the signal 37, along with the control signal. By the control signal being transmitted to the external apparatus 20B, the external apparatus 20B can output the sound effect in accordance with the content of the book 2. With the above configuration, the sound in the surrounding of the user as the surrounding environment of the user can be adjusted to the sound in accordance with the content of the book 2. Thus, since the user's hearing is stimulated by the sound effect in accordance with the content of the book 2, the user is more likely to sympathize with the content of the book 2.

As the control signal, the controller 33 may transmit, via the network 3 to the external apparatus 20B, a signal that causes output of music in accordance with the content of the book 2 using the communication interface 31. For example, when estimating that the content of the book 2 corresponds to the category 40, the controller 33 transmits the signal 52 to the external apparatus 20B. The controller 33 may transmit, to the external apparatus 20B, the data for reproducing the music that is stored in memory 32 in correspondence with the signal 53, along with the control signal. By the control signal being transmitted to the external apparatus 20B, the external apparatus 20B can output the music in accordance with the content of the book 2. With the above configuration, the sound in the surrounding of the user as the surrounding environment of the user can be adjusted to the sound in accordance with the content of the book 2. Thus, since the user's hearing is stimulated by the music in accordance with the content of the book 2, the user is more likely to sympathize with the content of the book 2.

As the control signal, the controller 33 may transmit, via the network 3 to the external apparatus 20C, a signal to cause diffusion of a fragrance in accordance with the content of the book 2 using the communication interface 31. The fragrance in accordance with the content of the book 2 may be a fragrance having a scent associated with the content of the book 2. For example, when estimating that the content of book 2 corresponds to the category 42, the controller 33 transmits the signal 58 to the external apparatus 20C. By the control signal being transmitted to the external apparatus 20C, the external apparatus 20C can diffuse the fragrance in accordance with the content of the book 2. With the above configuration, the scent in the surrounding of the user as the surrounding environment of the user can be adjusted to the scent in accordance with the content of the book 2. Thus, since the user's sense of smell is stimulated by the scent in accordance with the content of the book 2, the user is more likely to sympathize with the content of the book 2.

As the control signal, the controller 33 may transmit, via the network 3 to the external apparatus 20D, a signal to cause adjustment of the air temperature to be a temperature in accordance with the content of the book 2 using the communication interface 31. For example, when estimating that the content of book 2 corresponds to the category 43, the controller 33 transmits the signal 61 to the external apparatus 20D. By the control signal being transmitted to the external apparatus 20D, the external apparatus 20D can adjust the air temperature inside the room to the temperature in accordance with the content of the book 2. With the above configuration, the air temperature inside the room as the surrounding environment of the user can be adjusted to the temperature in accordance with the content of the book 2. Thus, since the user's sense of temperature is stimulated by the temperature in accordance with the content of the book 2, the user is more likely to sympathize with the content of the book 2.

As the control signal, the controller 33 may transmit, via the network 3 to the external apparatus 20E, a signal to cause projection of an image in accordance with the content of the book 2 using the communication interface 31. For example, when estimating that the content of the book 2 corresponds to the category 42, the controller 33 transmits the signal 59 to the external apparatus 20E. By the control signal being transmitted to the external apparatus 20E, the external apparatus 20E can project the image in accordance with the content of the book 2 to the wall or the like in the room. With the above configuration, the image projected onto the wall or the like of the room as the surrounding environment of the user can be adjusted to the image in accordance with the content of the book 2. Thus, since the user's vision is stimulated by the image in accordance with the content of the book 2, the user is more likely to sympathize with the content of the book 2.

<Start Processing>

The controller 33 may receive, via the network 3 from the cameras 10, the information indicating the identifiers of the cameras 10 and the data of captured images using the communication interface 31.

The controller 33 may start the aforementioned estimation processing for the content of the book 2 upon receiving, from the camera 10A, the information indicating the identifier of the camera 10A and the data of the captured image. As described above, the user may switch on the desk lamp 4 when they start reading the book 2. Further, when the desk lamp 4 is switched on, the camera 10A may transmit the information indicating the identifier of the camera 10A and the data of the captured image to the information processing apparatus 30. That is, the start of transmission of the data of the captured image or the like from the camera 10A to the information processing apparatus 30 may be regarded as the start of viewing of the book 2 by the user.

The controller 33 may start the aforementioned estimation processing for the content of the book 2 when detecting the book 2 in an open state from the captured image captured by any of the cameras 10. The user may leave the book 2 open while reading the book 2. The controller 33 may detect that the book 2 is in the open state from the captured image using object recognition in which any machine-learning algorithm is employed. As the captured image, the controller 33 may use a captured image captured by the camera 10B. Herein, in a case in which the camera 10B is a monitor camera, the data of captured images or the like can be continuously transmitted from the camera 10B to the information processing apparatus 30. Even when the data of the captured images or the like is continuously transmitted from the camera 10B to the information processing apparatus 30, the aforementioned estimation processing for the content of the book 2 can be appropriately started, since the aforementioned estimation processing for the content of the book 2 is started when the book 2 in the open state is detected from the captured image.

In the case in which the book 2 is an electronic book, the controller 33 may receive, via the network 3 from the book 2, a signal indicating activation of the book 2 using the communication interface 31. Upon receiving the signal, the controller 33 may start the aforementioned estimation processing for the content of the book 2.

<End Processing>

The controller 33 may end the aforementioned estimation processing for the content of the book 2 when the information indicating the identifier of the camera 10A and the data of the captured images is no longer being transmitted from the camera 10A to the information processing apparatus 30. As described above, the user may switch off the desk lamp 4 when they stop reading the book 2. Further, the camera 10A may terminate the transmission of the data of the captured images or the like to the information processing apparatus 30 when the desk lamp 4 is switched off. That is, the end of transmission of the data of the captured images or the like from the camera 10A to the information processing apparatus 30 may be regarded as the end of viewing of the book 2 by the user.

When, after detecting that the book 2 is in the open state from the captured images captured by the cameras 10, detecting the book 2 in a closed state from captured images captured by the cameras 10, the controller 33 may end the aforementioned estimation processing for the content of the book 2. When the user finishes reading the book 2, the book 2 may be brought into the closed state. The controller 33 may detect, from the captured image, that the book 2 is in the closed state using object recognition in which any machine-learning algorithm is employed. As the captured image, the controller 33 may use a captured image captured by the camera 10B. Herein, in the case in which the camera 10B is a monitor camera, the data of captured images or the like can be continuously transmitted from the camera 10B to the information processing apparatus 30. Even when the data of the captured images or the like is continuously transmitted from the camera 10B to the information processing apparatus 30, the estimation processing for the content of the book 2 can be appropriately ended, since the estimation processing for the content of the book 2 is ended when the book 2 in the closed state is detected from the captured image.

In the case in which the book 2 is an electronic book, the controller 33 may receive, via the network 3 from the book 2, a signal indicating that the book 2 is turning off using the communication interface 31. Upon receiving the signal, the controller 33 may end the estimation processing for the content of the book 2.

<Transmission Processing for Control Signal>

### Additional Example 1

The controller 33 may identify the user who is viewing the book 2. As described above, the camera 10B is located on the wall or the like in the room so as to be capable of capturing an image of the user, along with the book 2 as the subject. The controller 33 may identify the user from the captured image captured by the camera 10B using face recognition in which any machine-learning algorithm is employed. As one example using face recognition, the controller 33 identifies a facial image of the user from the captured image captured by the camera 10B. The controller 33 compares the identified facial image of the user with the facial image of each occupant included in the database for face recognition stored in the memory 32, and identify the facial image of the occupant having the highest degree of concordance with the identified facial image of the user. The controller 33 acquires, from the database for face recognition in the memory 32, the identifier of the occupant corresponding to the facial image of the occupant identified as having the highest degree of concordance as the identifier of the user who is viewing the book 2, thereby identifying the user who is viewing the book 2.

Upon identifying the user who is viewing the book 2, the controller 33 may acquire information on music for which the user has a preference. The controller 33 may receive, via the network 3 from the external server 5, the information on the music for which the user has a preference using the communication interface 31. The external server 5 may be a server that provides a music distribution service. The external server 5 may be a server that distributes music to a smartphone used by the user and/or the external apparatus 20B. The external server 5 may estimate the music for which the user has a preference, by analyzing the type or the like of the music distributed to the smartphone or the like of the user using machine learning, for example. The information on the music may include information on a title to the music, data for reproducing the music, and the like. The music may be tagged with any text by any user who has used the external server 5. Herein, the controller 33 may transmit, via the network 3 to the external server 5, a notification instructing the transmission of the information on the music for which the user has a preference, along with the information indicating the identifier of the user, using the communication interface 31. Upon receiving the notification or the like, the external server 5 can transmit, via the network 3 to the information processing apparatus 30, the information on the music for which the user has a preference. Further, the controller 33 may receive, via the network 3 from the external server 5, information on the type of the music distributed to the smartphone or the like of the user using the communication interface 31. The controller 33 may acquire the information on the music for which the user has a preference, by analyzing the information on the type of the music distributed to the smartphone or the like of the user using machine learning, for example.

The controller 33 may select, from the acquired music for which the user has a preference, any music in accordance with the estimated content of the book 2.

As an example, as the music in accordance with the estimated content of the book 2, the controller 33 may select, from the acquired music for which the user has a preference, music that is tagged with the text related to the category of scene estimated in the aforementioned estimation processing. The controller 33 may estimate whether the text is related to the category of scene by executing, for the text, natural language processing in which any machine-learning algorithm is employed. For example, when estimating that the content of the book 2 corresponds to the category 40 in the aforementioned estimation processing, the controller 33 estimates that the text “song to listen to when in grief” tagged to certain music included in the music for which the user has a preference is related to the category 40. The controller 33 selects, from the acquired music for which the user has a preference, the music tagged with the text “song to listen to when in grief”, as the music in accordance with the content of the book 2.

As another example, as the music in accordance with the estimated content of the book 2, the controller 33 may select, from the acquired music for which the user has a preference, music having a title that is estimated to be related to the category of scene estimated in the aforementioned estimation processing. The controller 33 may estimate that the title to the music is related to the category of scene, by executing, for the title to the music, natural language processing in which any machine-learning algorithm is employed. For example, when it is estimated that the content of the book 2 corresponds to the category 40 in the aforementioned estimation processing, the controller 33 estimates that the title “grief song” to certain music included in the acquired music for which the user has a preference is related to the category 40. The controller 33 selects, from the acquired music for which the user has a preference, the music with the title “grief song”, as the music in accordance with the content of the book 2.

As a control signal, the controller 33 may transmit, via the network 3 to the external apparatus 20B, a signal to cause output of the selected music using the communication interface 31. The controller 33 may transmit, along with the signal, the data for reproducing the music to the external apparatus 20B.

### Additional Example 2

The controller 33 may identify the user who is viewing the book 2 and receive, via the network 3 from the external server 5, information on a list 6 of music associated with the identified user using the communication interface 31. The list 6 of music may be a list of music made in the past due to a previous use of the external server 5 by the user who is viewing the book 2. The list 6 of music may include information on a title to the music, data for reproducing the music, and the like. In the list 6 of music, the music may be tagged with any text. The tagging for the music may be made in the past by the user who is viewing the book 2. The controller 33 may identify the user who is viewing the book 2 in the same manner as in Additional Example 1 described above. The controller 33 may transmit, via the network 3 to the external server 5, a notification instructing the transmission of the list 6 of music associated with the user, along with the information indicating the identifier of the user, using the communication interface 31. Upon receiving the notification or the like, the external server 5 may transmit, via the network 3 to the information processing apparatus 30, the information on the list 6 of music.

The controller 33 may select any music in accordance with the content of the book 2 from the list 6 of music associated with the user.

As an example, as the music in accordance with the estimated content of the book 2, the controller 33 may select, from the music included in the list 6 of music, the music that is tagged with the text estimated to be related to the category of scene estimated in the aforementioned estimation processing, in the same manner as in Additional Example 1.

As another example, as the music in accordance with the content of the book 2, the controller 33 may select, from the music included in the list 6 of music, the music having a title estimated to be related to the category of scene estimated in the aforementioned estimation processing, in the same manner as in Additional Example 2.

As a control signal, the controller 33 may transmit, via the network 3 to the external apparatus 20B, a signal to cause output of the selected music using the communication interface 31. The controller 33 may transmit, along with the signal, the data for reproducing the music received from the external server 5, to the external apparatus 20B.

### Additional Example 3

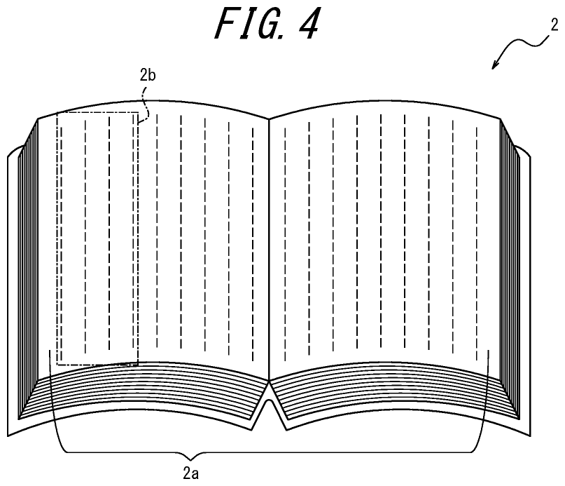

The controller 33 may identify, from among the text that the book 2 presents to the user, a segment corresponding to the content of the book 2. The text that the book 2 presents to the user is also described as “presented text” hereinafter. The presented text is, for example, presented text 2a displayed on a page facing the user of the book 2, as illustrated in FIG. 4. In a case in which the content of the book 2 is estimated by estimating the meaning of the text in the aforementioned estimation processing for the content of the book 2, the controller 33 may identify a segment in the presented text in which the text used for the estimation of the meaning is located, as the segment corresponding to the content of the book 2. For example, in a case in which the content of the book 2 is estimated by estimating the meaning of the text located at the segment 2b in the aforementioned estimation processing for the content of the book 2, the controller 33 identifies the segment 2b in the presented text 2a as the segment corresponding to the content of the book 2.

The controller 33 may estimate a timing at which the user is to view the segment corresponding to the content of the book 2. For example, the controller 33 estimates a timing at which the user is to view the segment 2b as illustrated in FIG. 4. The controller 33 may estimate, as the timing for the segment corresponding to the content of the book 2 to be viewed, an amount of time that elapses from when the user turns pages of the book 2 to when the user views the segment corresponding to the content of the book 2. The controller 33 may estimate the amount of time that elapses, by estimating a rate at which the user reads the text. The controller 33 may estimate the rate at which the user reads the text, by detecting the number of characters displayed on the page of the book 2 and a time interval at which the user turns pages of the book 2, using the captured images captured by the cameras 10 and object recognition in which any machine-learning algorithm is employed. Further, in the case in which the book 2 is an electronic book, the controller 33 may estimate the rate at which the user reads the text, by receiving, via the network 3 from the book 2, the information that the book 2 presents to the user using the communication interface 31 and analyzing the received information.

The controller 33 may transmit, via the network 3 to the external apparatuses 20A, 20B that are capable of outputting sound and/or light, a timing signal as the control signal using the communication interface 31. The timing signal is a signal to cause output of the sound and/or the light at the timing at which the user views the segment corresponding to the content of the book 2. The timing signal may be a signal that causes the external apparatuses 20A, 20B to output illumination light having a color, illumination light having an intensity, a sound effect, and/or music that are in accordance with the estimated content of the book 2, at the timing at which the user views the segment corresponding to the content of the book 2.

<Additional Example of Estimation Processing>

The controller 33 may detect the time interval at which pages of the book 2 are turned. The controller 33 may execute the aforementioned estimation processing for the content of the book 2 at an interval shorter than the time interval detected. Upon executing the aforementioned estimation processing for the content of the book 2, the controller 33 may execute the aforementioned transmission processing for the control signal. Herein, the controller 33 may detect the time interval at which pages of the book 2 are turned, using the captured images captured by the cameras 10 and object recognition in which any machine-learning algorithm is employed. In the case in which the book 2 is an electronic book, the controller 33 may detect the time interval at which pages of the book 2 are turned, by receiving, from the book 2, the information that the book 2 presents to the user using the communication interface 31 and analyzing the received information.

(Operations of Information Processing System)

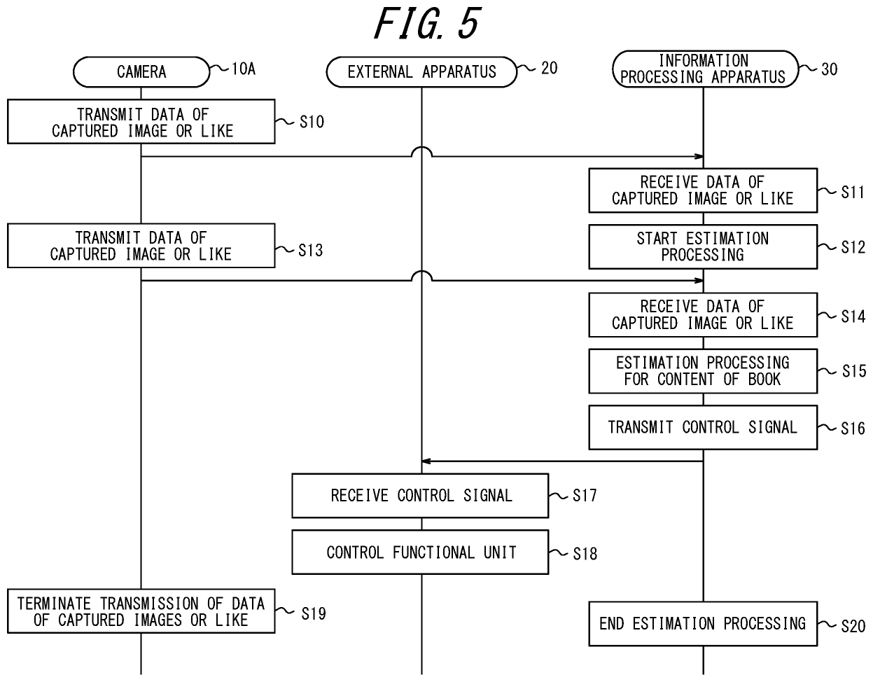

Referring to FIG. 5, an example of operations of the information processing system 1 illustrated in FIG. 1 will be described. The operations may correspond to an example of an information processing method according to the present embodiment. Hereinafter, it is assumed that the information processing apparatus 30 uses captured images captured by the camera 10A.

In the camera 10A, the controller 14 transmits, via the network 3 to the information processing apparatus 30, the information indicating the identifier of the camera 10A and data of a captured image captured by the imager 12 using the communication interface 11, when the desk lamp 4 is switched on (Step S10). In the information processing apparatus 30, the controller 33 receives, via the network 3 from the camera 10A, the information indicating the identifier of the camera 10A and the data of the captured image using the communication interface 31 (Step S11). The controller 33 of the information processing apparatus 30 starts the estimation processing for estimating the content of the book 2 (Step S12).

In the camera 10A, the controller 14 transmits, via the network 3 to the information processing apparatus 30, the information indicating the identifier of the camera 10A and data of a captured image captured by the imager 12 using the communication interface 11 (Step S13). In the information processing apparatus 30, the controller 33 receives, via the network 3 from the camera 10A, the information indicating the identifier of the camera 10A and the data of the captured image using the communication interface 31 (Step S14). The controller 33 of the information processing apparatus 30 executes the estimation processing for estimating the content of the book 2, by analyzing the data of the captured image received from the camera 10A (Step S15). In the information processing apparatus 30, the controller 33 transmits, to the external apparatuses 20, the control signal in accordance with the estimated content of the book 2 using the communication interface 31 (Step S16). In each external apparatus 20, the controller 24 receives, via the network 3 from the information processing apparatus 30, the control signal using communication interface 21 (Step S17). In the external apparatus 20, the controller 24 controls the functional unit 22 in response to the received control signal (Step S18).

In the camera 10A, the controller 14 terminates the transmission of the data of the captured images or the like to the information processing apparatus 30, when the desk lamp 4 is switched off (Step S19). Due to the process of Step S19, the information indicating the identifier of the camera 10A and the data of the captured images is no longer being transmitted from the camera 10A to the information processing apparatus 30. In the information processing apparatus 30, the controller 33 ends the estimation processing for the content of the book 2 (Step S20).

Thus, in the information processing system 1, the information processing apparatus 30 executes the estimation processing for estimating the content of the book 2. The information processing apparatus 30 transmits, to the external apparatuses 20, the control signal in accordance with the content of the book 2. By the control signal being transmitted to the external apparatuses 20, the functions of the external apparatuses 20 can be controlled in accordance with the estimated content of the book 2. With the above configuration, the environment inside the room as the surrounding environment of the user can be adjusted in accordance with the estimated content of the book 2.

Further, in the information processing system 1, the external apparatus 20A serving as the ceiling light can be caused to output the illumination light having the color and the intensity that are in accordance with the content of the book 2, with the illumination light from the desk lamp 4 being unchanged. The user can read the book 2 under the illumination light from the desk lamp 4. With the illumination light from the desk lamp 4 being unchanged, the surrounding environment of the user may be adjusted while the environment in which the user reads the book 2 is maintained as a pleasant environment.

The present disclosure is not limited to the embodiment described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the gist of the present disclosure.

For example, in the description of the above embodiment, it is assumed that the user is inside the room. The user may, however, be outside the room. For example, the user may be outside the home. In this case, the external apparatus 20 may be the one corresponding to an external environment. For example, the external apparatus 20B includes an earphone. The user may listen to the sound effect and/or the music outputted by the external apparatus 20B through the earphone of the external apparatus 20B.

For example, in the description of the above embodiment, it is assumed that the camera 10, the external apparatuses 20, and the information processing apparatus 30 are separate apparatuses. The camera 10, the external apparatuses 20, and the information processing apparatus 30, however, do not need to be separate apparatuses. For example, the camera 10, the external apparatuses 20, and the information processing apparatus 30 are configured as a single glasses-type wearable terminal that provides augmented reality. The glasses-type wearable terminal may include transparent lenses. The transparent lenses enable the user to view the book 2 with the glasses-type wearable terminal on. In the glasses-type wearable terminal, the cameras 10 may be located at edges of the lenses so as to be capable of capturing an image of the book 2 as the subject. As in the above embodiment, an element of the glasses-type wearable terminal that corresponds to the information processing apparatus 30 estimates the content of the book 2 by analyzing captured images captured by the cameras 10. As in the above embodiment, the element of the glasses-type wearable terminal that corresponds to the information processing apparatus 30 may transmit the control signal in accordance with the estimated content of the book 2 to elements of the glasses-type wearable terminal that correspond to the external apparatuses 20. The elements of the glasses-type wearable terminal that correspond to the external apparatuses 20 may be small-sized projection apparatuses that project an image onto the retina of the user. The projection apparatuses may project an image or the like corresponding to the received control signal onto the retina of the user.

1. An information processing apparatus comprising:
a communication interface; and
a controller configured to execute estimation processing for estimating content of a book, and transmit, to an external apparatus, a control signal in accordance with the content of the book using the communication interface.

2. The information processing apparatus according to claim 1, wherein
the external apparatus is a lighting apparatus, and
as the control signal, the controller is configured to transmit, to the lighting apparatus, a signal to cause output of illumination light having a color in accordance with the content of the book using the communication interface.

3. The information processing apparatus according to claim 1, wherein
the external apparatus is a lighting apparatus, and
as the control signal, the controller is configured to transmit, to the lighting apparatus, a signal to cause output of illumination light having an intensity in accordance with the content of the book using the communication interface.

4. The information processing apparatus according to claim 2, wherein
the lighting apparatus is a ceiling light.

5. The information processing apparatus according to claim 1, wherein
the external apparatus is an acoustic apparatus, and
as the control signal, the controller is configured to transmit, to the acoustic apparatus, a signal to cause output of a sound effect in accordance with the content of the book using the communication interface.

6. The information processing apparatus according to claim 1, wherein
the external apparatus is an acoustic apparatus, and
as the control signal, the controller is configured to transmit, to the acoustic apparatus, a signal to cause output of music in accordance with the content of the book using the communication interface.

7. The information processing apparatus according to claim 1, wherein
the controller is configured to identify a user who is viewing the book, and select, from music for which the user has a preference, music in accordance with the content of the book.

8. The information processing apparatus according to claim 1, wherein
the controller is configured to identify a user who is viewing the book, receive information on a list of music associated with the user from an external server using the communication interface, and select, from the list, music in accordance with the content of the book.

9. The information processing apparatus according to claim 1, wherein
the external apparatus is an apparatus configured to output sound and/or light, and
the controller is configured to:
identify, from among text that the book presents to the user, a segment corresponding to the content of the book, and estimate a timing at which the user is to view the segment; and
as the control signal, transmit, to the external apparatus, a signal to cause output of sound and/or light at the timing using the communication interface.

10. The information processing apparatus according to claim 1, wherein
the controller is configured to detect a time interval at which pages of the book are turned, and execute the estimation processing at an interval shorter than the time interval.

11. The information processing apparatus according to claim 1, wherein
as the estimation processing, the controller, upon determining that the content of the book corresponds to a predefined scene, estimates that the content of the book is of the scene.

12. The information processing apparatus according to claim 11, wherein
the scene is predefined based on human emotion.

13. The information processing apparatus according to claim 11, wherein
the scene is predefined based on scenery.

14. The information processing apparatus according to claim 11, wherein
the control signal is associated with the scene in advance.

15. The information processing apparatus according to claim 1, wherein
the controller is configured to execute the estimation processing by analyzing captured images of the book captured by a camera.

16. The information processing apparatus according to claim 15, wherein
the camera generates the captured images while a desk lamp is switched on, and
the controller:
starts the estimation processing upon receiving data of the captured images from the camera; and
ends the estimation processing when the data of the captured images is no longer being transmitted from the camera to the information processing apparatus.

17. The information processing apparatus according to claim 15, wherein
the controller starts the estimation processing upon detecting that the book is in an open state from the captured images captured by the camera.

18. The information processing apparatus according to claim 17, wherein
the controller ends the estimation processing upon, after detecting that the book is in the open state from the captured images captured by the camera, detecting that the book in a closed state from the captured images captured by the camera.

19. A non-transitory computer readable medium storing a program configured to cause a computer to execute operations, the operations comprising:
executing estimation processing for estimating content of a book; and
transmitting, to an external apparatus, a control signal in accordance with the content of the book.

20. An information processing method comprising:
executing estimation processing for estimating content of a book using an information processing apparatus; and
transmitting, to an external apparatus, a control signal in accordance with the content of the book using the information processing apparatus.
